(19) United States
(12) Patent Application Publication
(10) Pub. No.: US 2018/0090093 A1
(43) Pub. Date: Mar. 29, 2018

(54) TIMING CONTROLLER, SOURCE DRIVER IC AND SOURCE DRIVING METHOD

(71) Applicant: BOE TECHNOLOGY GROUP CO., LTD., Beijing (CN)

(72) Inventor: Yanfeng WANG, Beijing (CN)

(21) Appl. No.: 15/520,791

(22) PCT Filed: Aug. 24, 2016
(86) PCT No.: PCT/CN2016/096507

§ 371 Date: Apr. 20, 2017

(30) Foreign Application Priority Data
Jan. 4, 2016 (CN) 201610004363.1

(51) Int. Cl. G09G 3/36

(52) U.S. Cl. CPC G09G 3/3688; G09G 3/3614; G09G 2360/02; G09G 2300/0408; G09G 2310/08

(57) ABSTRACT

The present disclosure relates to a timing controller, a source driver IC and a source driving method. The timing controller comprises an encoding module and at least one first output port. Each of the first output ports can be configured to be electrically connected with at least two source driver ICs of a display panel. The encoding module can be configured to provide the same driving signal to all the first output ports, the driving signal at least carrying IC addresses and pixel data of the source driver ICs. The encoding module provides the driving signal to the first output ports, such that one of the first output ports outputs pixel data of at least two of the source driver ICs, which decreases the number of the output ports and reduces the production cost of the timing controller.

### TECHNICAL FIELD

The present disclosure relates to the field of liquid crystal display (LCD) technology, and more particularly to a timing controller, a source driver integrated circuit IC and a source driving method.

### BACKGROUND

A Timing controller, also known as a Timing control circuit or a logic board circuit, is a key component used by a LCD to display current video image signals and can convert multiple signals containing video data, such as VGA signals, AV signals and HDMI signals, into pixel data displayed on the LCD. The Timing controller is often located between the LCD and a front-end signal processing circuit, and the video data processed by the front-end signal processing circuit shall be converted by the Timing controller before being applied to the LCD for image reproduction.

FIG. 1 is a view showing the connection between a source driver integrated circuit IC and a Timing controller of a typical display panel. The Timing controller 1 comprises a plurality of output ports 3 with each being electrically connected with a source driver IC 4. As the resolution of the LCD tends to become increasingly higher, however, if the output port of the Timing controller is still electrically connected with the source driver IC in a one-to-one manner, increasing of the resolution of the LCD will result in increasing of the output ports of the Timing controller, thereby leading to an increase in production cost of the Timing controller.

### SUMMARY

To overcome the defect of the prior art, it is desirable to provide a Timing controller, a source driver IC and a source driving method, which can solve the problem that an increase in the resolution of the LCD will require more output ports of the Timing controller, thereby leading to an increase in the production cost of the Timing controller.

According to a first aspect, there is provided a Timing controller. The Timing controller may comprise:

at least one first output port, each of which may be configured to be electrically connected with at least two source driver integrated circuits IC of a display panel; and

an encoding module that may be configured to provide the same driving signal to all the first output ports, the driving signal at least carrying IC addresses of the source driver ICs with which all the first output ports are electrically connected and pixel data corresponding to the source driver ICs.

In the above Timing controller, the encoding module provides the first output ports with the driving signal at least carrying IC addresses and pixel data of the source driver ICs, such that one of the first output ports outputs pixel data of at least two of the source driver ICs, which decreases the number of the output ports and reduces the production cost of the Timing controller.

In an embodiment, the Timing controller may further comprise:

an input port that may be configured to receive video data; and

a data processing module that may be configured to convert the video data received by the input port into the pixel data corresponding to display panel pixel columns, and providing the pixel data to the encoding module.

In an embodiment, the encoding module can be configured to encode and generate the driving signal according to the pixel data, and provide the driving signal to all the first output ports. In the present embodiment, the encoding module can generate the driving signal by encoding the pixel data generated by the data processing module. In an embodiment, in the driving signal generated by the encoding module, the IC addresses and the pixel data correspond to each other in a one-to-one relationship and are matched in a prescribed timing. In the present embodiment, the IC addresses and the pixel data of the source driver IC correspond to each other in a one-to-one relationship and are matched in a prescribed timing. Thus, after the timing controller provides the driving signal to all the source driver ICs, each source driver IC can receive/decode the pixel data corresponding to its IC address by its IC address.

In an embodiment, the driving signal can also carry port information and/or control signal information of the first output ports. In the present embodiment, the driving signal also carries the port information of the first output ports so that the timing controller can distribute the pixel data of the source driver ICs to the source drive ICs in a faster and more effective manner.

In an embodiment, the control signal may comprise one or several signals selected from the group consisting of an initial triggering signal, a clock signal, a latch signal and a polarity reversal signal.

In an embodiment, the number of the first output ports may be one, and the one first output port is electrically connected with all the source driver ICs of the display panel. Alternatively, the number of the first output ports may be at least two, and all the first output ports are electrically connected with all the source driver ICs of the display panel, and each of the first output ports is electrically connected with a portion of the source driver ICs of the display panel.

According to a second aspect, there is provided a timing controller. The timing controller may comprise:

at least one first output port, each of which is configured to be electrically connected with at least two source driver integrated circuits IC;

a second output port configured to be electrically connected with the source driver ICs with which all the first output ports are electrically connected; and

an encoding module configured to provide the same driving signal to all the first output ports, the driving signal at least carrying pixel data corresponding to the source driver ICs with which all the first output ports are electrically connected, and the encoding module also configured to provide the second output port with an address signal carrying the IC addresses of the source driver ICs.

In the above timing controller, the encoding module provides the first output ports with the driving signal at least carrying pixel data of the source driver ICs, and provides the second output port with the IC addresses of the source driver ICs, such that one of the first output ports outputs pixel data of at least two source driver ICs, which decreases the number of the output ports and reduces the production cost of the timing controller. The address signals and the driving signal are sent separately, which reduces the amount of data outputted by the timing controller at the same time and thereby lowers the requirement of the timing controller for band width while decreasing the number of output ports.

In an embodiment, the timing controller may further comprise:

an input port that may be configured to receive video data; and

a data processing module that may be configured to convert the video data received by the input port into the pixel data corresponding to display panel pixel columns, and provide the pixel data to the encoding module.

In an embodiment, the encoding module can be configured to encode and generate the driving signal based on the pixel data, generate the address signal matching the pixel data, and provide the driving signal to all the first output ports and the address signal to the second output port. In the present embodiment, the encoding module can generate the driving signal and the address signal by encoding the pixel data generated by the data processing module.

In an embodiment, the IC addresses of the source driver ICs in the address signal and the pixel data in the driving signal correspond to each other in a one-to-one relationship and are matched in a prescribed timing. In the present embodiment, the IC addresses of the source driver ICs in the address signal and the pixel data in the driving signal correspond to each other in a one-to-one relationship and are matched in a prescribed timing, so that, after the timing controller provides the address signal and the driving signal to all the source driver ICs, each source driver IC can receive the pixel data corresponding to its IC address by its IC address.

In an embodiment, the driving signal can also carry port information and/or control signal information of the first output ports. In the present embodiment, the driving signal also carries the port information of the first output ports so that the timing controller can distribute the pixel data of the source driver ICs to the source drive ICs in a faster and more effective manner.

In an embodiment, the control signal may comprise one or several signals selected from the group consisting of an initial triggering signal, a clock signal, a latch signal and a polarity reversal signal.

In an embodiment, the number of the first output ports may be one, and the one first output port is electrically connected with all the source driver ICs of the display panel. Alternatively, the number of the first output ports may be at least two, and all the first output ports are electrically connected with all the source driver ICs of the display panel, and each of the first output ports is electrically connected with a portion of the source driver ICs of the display panel.

According to a third aspect, there is provided a source driver integrated circuit IC. The source driver integrated circuit IC may be configured to be electrically connected with any timing controller according to the first aspect as described above. The source driver IC may comprise:

a first receiving port configured to receive a driving signal outputted by a first output port of the timing controller; and

a decoding module configured to determine whether a current IC address in the driving signal matches a prestored address of the source driver IC, and configured to acquire the pixel data in the driving signal that corresponds to the current IC address if they match.

The decoding module arranged in the source driver IC is used to provide the current source driver IC with the pixel data in the driving signal that match the address of the source driver IC when the address of the source driver IC in the driving signal matches the address of the source driver IC, so that the source driver IC can obtain the pixel data outputted by the timing controller and required by the source driver IC.

According to a fourth aspect, there is provided a source driver integrated circuit IC. The source driver IC may be configured to be electrically connected with any timing controller according to the second aspect as described above. The source driver IC may comprise:

a first receiving port that may be configured to receive a driving signal outputted by the first output port of the timing controller;

a second receiving port that may be configured to receive an address signal carrying the IC addresses of the source driver ICs and outputted by the second output port of the timing controller; and

a decoding module that may be configured to determine whether a current IC address in the address signal matches a prestored address of the source driver IC, and configured to acquire the pixel data in the driving signal that corresponds to the current IC address if they match.

The decoding module arranged in the source driver IC is used to parse the address signal of the source driver ICs outputted by the timing controller according to the second aspect, and, when the address of the source driver IC matches the address of the current source driver IC, to parse the pixel data corresponding to the address of the source driver IC and outputted by the first output ports of the timing controller and to provide the current source driver IC with the pixel data of the source driver IC, so that the source driver IC can obtain the pixel data outputted by the timing controller and required by the source driver IC.

According to a fifth aspect, there is provided a source driving method. The method drives at least two source driver integrated circuits IC according to the third aspect by any timing controller according to the first aspect. The method comprises the steps of:

electrically connecting each first output port of the timing controller with at least two source driver ICs beforehand;

providing, in the timing controller, the same driving signal to all the first output ports by an encoding module, wherein the driving signal at least carries the IC addresses of the source driver ICs with which all the first output ports are electrically connected and the pixel data corresponding to the source driver ICs;

each of the source driver ICs receiving by the first receiving port thereof the driving signal outputted by the first output ports of the electrically connected timing controller;

in each of the source driver ICs, determining, by the decoding module, whether the current IC address in the driving signal matches the prestored address of the source driver IC in which the decoding module itself is located, and acquiring the pixel data in the driving signal that corresponds to the current IC address if they match; and

each of the source driver ICs driving a data line of a display panel according to the acquired pixel data.

In the above method, the timing controller outputs the driving signal at least carrying the addresses of the source driver ICs and the pixel data corresponding to the source driver ICs. The decoding module of the source driver IC parses the driving signal, and provides the current source driver IC with the pixel data of the source driver IC in the output signal when the address of the source driver IC in the driving signal matches the address of the current source driver IC. In doing so, the driving signal outputted by the timing controller can be parsed by the source driver IC and the source driver IC can acquire the required pixel data, so that the timing controller having fewer output ports can output the pixel data required by the source driver IC, and the source driver IC can drive the pixel unit for display.

According to a sixth aspect, there is provided a source driving method. The method drives at least two source driver integrated circuits IC according to the fourth aspect by any timing controller according to the second aspect. The method comprises the steps of:

electrically connecting each first output port of the timing controller with at least two source driver ICs and electrically connecting a second output port of the timing controller with all the source driver ICs beforehand;

providing, in the timing controller, the same driving signal to all the first output ports and an address signal to the second output port by the encoding module, wherein the address signal carries the IC addresses of the source driver ICs with which all the first output ports are connected, and the driving signal at least carries the pixel data corresponding to the source driver ICs with which all the first output ports are electrically connected;

each of the source driver ICs receiving by the second receiving port thereof the address signal outputted by the second output port of the timing controller electrically connected with the source driver ICs, and receiving by the first receiving port thereof the driving signal outputted by the first output ports of the timing controller electrically connected with the source driver ICs;

in each of the source driver ICs, determining, by the decoding module, whether the current IC address in the address signal matches the prestored address of the source driver IC in which the decoding module itself is located, and acquiring the pixel data in the driving signal that corresponds to the current IC address if they match; and

each of the source driver ICs driving a data line of a display panel according to the acquired pixel data.

In the above method, the first output ports of the timing controller outputs the driving signal at least carrying the pixel data corresponding to the source driver ICs, and the second output port of the timing controller outputs the addresses of the source driver ICs. The decoding module of the source driver IC parses the address signal, and provides the current source driver IC with the pixel data corresponding to the address of the source driver IC in the driving signal when the address of the source driver IC in the driving signal matches the address of the current source driver IC. In doing so, the address signal outputted by the timing controller can be parsed by the source driver IC and the source driver IC can acquire the required pixel data, so that the timing controller having fewer output ports can output the pixel data required by the source driver IC, and the source driver IC can drive the pixel unit for display.

### BRIEF DESCRIPTION OF DRAWINGS

To explain the technical solutions in the embodiments more clearly, the drawings necessary for describing the embodiments will be briefly introduced. It should be realized that the following drawings are only related to some embodiments. Those skilled in the art can obtain other drawings according to these drawings without making inventive effort. The other drawings also fall within the scope of the present invention.

FIG. 1 is a schematic view illustrating the connection between a typical timing controller and source driver ICs;

FIG. 2 is a schematic view illustrating the connection between a timing controller and source driver ICs according to an embodiment;

FIG. 3 is a structural schematic view of the timing controller according to an embodiment;

FIG. 4 is a schematic view illustrating the relation between an address signal and a driving signal outputted by the timing controller according to an embodiment;

FIG. 5 is a schematic view illustrating the connection between a timing controller and source driver ICs according to an embodiment;

FIG. 6 is a structural schematic view of the timing controller according to an embodiment;

FIG. 7 is a schematic view illustrating the relation between an address signal and a driving signal outputted by the timing controller according to an embodiment;

FIG. 8 is a structural schematic view of the source driver IC according to an embodiment;

FIG. 9 is a structural schematic view of the source driver IC according to an embodiment;

FIG. 10 is a flowchart of a method for driving the source driver IC according to an embodiment; and

FIG. 11 is a flowchart of a method for driving the source driver IC according to an embodiment.

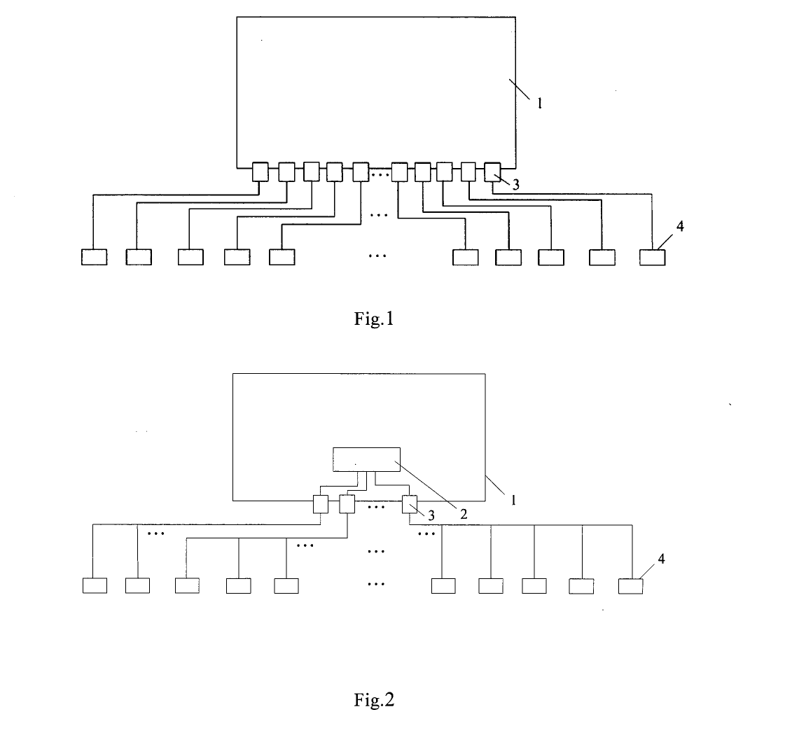

### DETAILED DESCRIPTION

For better understanding of the object, technical solutions and advantages of some embodiments, the embodiments will be further described in detail with reference to drawings and examples. It should be noted that identical or similar reference signs always indicate identical or similar elements or elements having identical or similar functions. The following examples described with reference to the drawings are exemplary and only used to explain the present invention, rather than limit the present invention.

With reference to FIG. 2, there is provided a timing controller 1 according to an embodiment. As shown, the timing controller 1 may comprise an encoding module 2 and at least one first output port 3. Each first output port 3 is electrically connected at one end with the encoding module 2 of the timing controller and at the other end with a source driver integrated circuit IC 4 of a display panel, wherein each first output port 3 is electrically connected with at least two source driver integrated circuits IC 4.

In specific implementation, the number of the first output ports 3 of the timing controller 1 and the number of the source driver ICs 4 electrically connected with the first output ports 3 can be specifically decided according to needs. For example, the timing controller 1 may comprise one first output port 3 that is electrically connected with all the source driver ICs 4. Another example is that the timing controller 1 may comprise two first output ports 3 that are each connected with a half part of the source driver ICs 4. The two first output ports 3 may also be electrically connected with all the source driver ICs 4 in an unequal way. That is, one of the first output ports 3 is electrically connected with fewer source driver ICs 4 and the other of the first output ports 3 is electrically connected with more remaining source driver ICs 4.

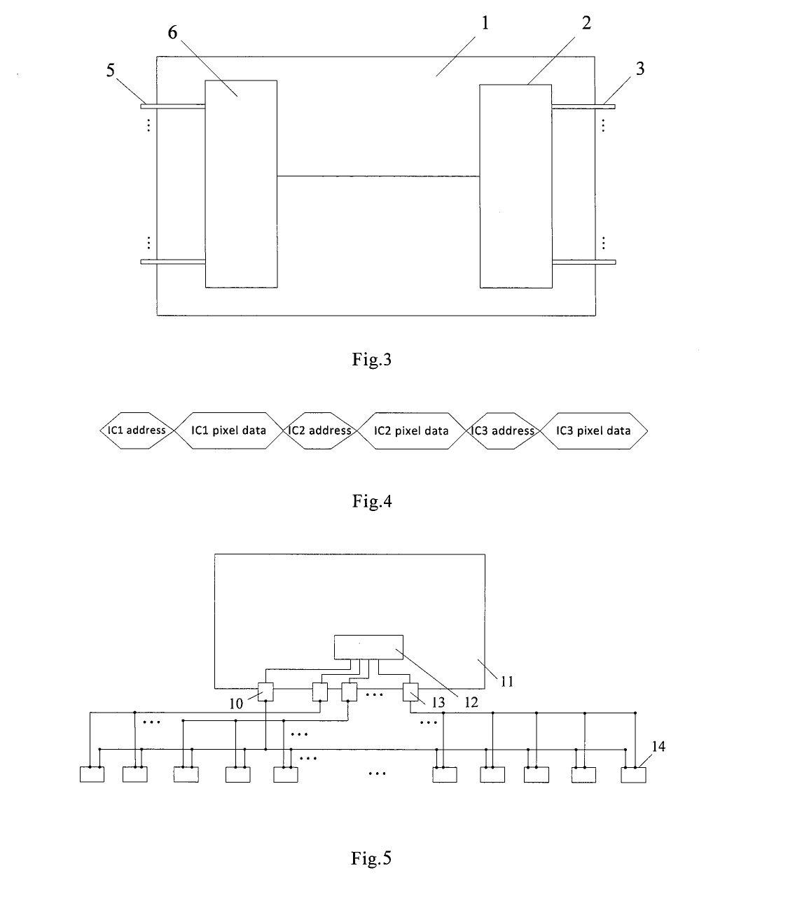

FIG. 3 is a structural schematic view of the timing controller 1 in FIG. 2. Similar to FIG. 2, the timing controller 1 may comprise an encoding module 2 and at least one first output port 3. Moreover, as shown in FIG. 3, the timing controller 1 may also comprise an input port 5 and a data processing module 6 that is electrically connected at one end with the input port 5 and at the other end with the encoding module 2.

The input port 5 can be configured to receive video data provided by a front-end processing circuit.

The data processing module 6 can be configured to convert the video data into pixel data corresponding to display panel pixel columns and provide the pixel data to the encoding module.

The encoding module 2 can be configured to encode and generate the driving signal based on the pixel data, wherein the driving signal at least carries IC addresses of the source driver ICs 4 with which all the first output ports 3 are electrically connected and the pixel data corresponding to the source driver ICs 4. In an embodiment, the driving signal may also carry port information and/or control signal information of the first output ports 3. When the driving signal carries the port information of the first output ports 3, the amount of data transmitted by the first output ports can be reduced, and when the timing controller outputs the signal required by the source driver ICs with fewer ports, the requirement of the output ports for bandwidth can be lowered.

In an embodiment, in the driving signal generated by the encoding module 2, the IC addresses and the pixel data correspond to each other in a one-to-one relationship and are matched in a prescribed timing. That is, the IC address and the pixel data for each of the source driver ICs correspond to each other in a one-to-one relationship and are matched in a prescribed timing, and both correspond to one source driver IC 4, so that when the driving signal is transmitted to all the source driver ICs 4, each source driver IC 4 can identify and receive the pixel data in the driving signal that corresponds to the source driver IC 4 according to the IC address thereof and the IC address carried in the driving signal, and provide the data line with the pixel data pertaining to the source driver IC 4. As shown in FIG. 4, it illustrates a schematic view illustrating the specific timing match between the IC address and the pixel data of the source driver ICs.

In an embodiment, the driving signal can also carry control signal information. The control signal may comprise one or several signals selected from the group consisting of an initial triggering signal, a clock signal, a latch signal and a polarity reversal signal. By enabling the driving signal to carry the control signal information, it can further reduce the number of output ports, thereby avoiding the circumstance that the timing controller also needs additional output ports to output the control signals required by the source driver ICs or gate driver ICs.

The encoding module of the timing controller described with reference to FIGS. 2 to 4 provides the first output port with the driving signal that at least carries the addresses and pixel data of the source driver ICs, such that the first output ports each can at least output the pixel data of two source driver ICs, thereby reducing the number of the output ports and lowering the production cost of the timing controller.

According to another embodiment, there is provided another timing controller 11. With reference to FIG. 5, the timing controller 11 may comprise an encoding module 12, at least one first output port 13, and a second output port 10. Each of the first output ports 13 and the second output port 10 are electrically connected at one end with the encoding module 12 of the source controller 11 and at the other end with the source driver ICs 14 of the display panel, wherein each of the first output ports 13 is at least electrically connected with two source driver ICs 14, and the second output port 10 is electrically connected with all the source driver ICs 14.

In specific implementation, the number of the first output ports 13 of the timing controller 11 and the number of the source driver ICs 14 electrically connected with the first output ports 13 can be specifically decided according to needs. For example, the timing controller 11 may comprise one first output port 13 that is electrically connected with all the source driver ICs 14. Another example is that the timing controller 11 may comprise two first output ports 13 that are each connected with a half part of the source driver ICs 14. The two output ports 13 may also be electrically connected with all the source driver ICs 14 in an unequal way. That is, one of the first output ports 13 is electrically connected with fewer source driver ICs 14 and the other of the first output ports 13 is electrically connected with more remaining source driver ICs 14.

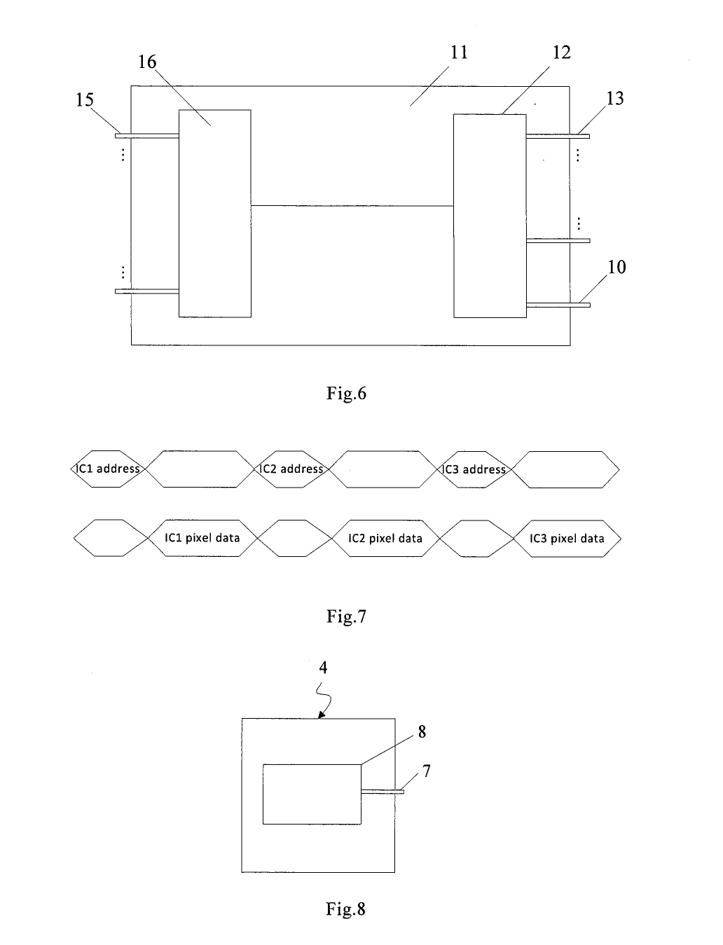

FIG. 6 is a structural schematic view of the timing controller 11 in FIG. 5. Similar to FIG. 5, the timing controller 11 may comprise an encoding module 12 and at least one first output port 13 and a second output port 10. Moreover, as shown in FIG. 6, the timing controller 11 may also comprise an input port 15 and a data processing module 16.

The input port 15 can be configured to receive video data provided by a front-end processing circuit.

The data processing module 16 can be configured to generate pixel data corresponding to display panel pixel columns according to the video data and provide the pixel data to the encoding module.

The encoding module 12 can be configured to encode and generate the driving signal based on the pixel data, and generate the address signal matching the pixel data, and to provide the driving signal to all the first output ports 13 and the address signal to the second output port 10. Wherein the driving signal at least carries the pixel data of the source driver ICs 14 with which all the first output ports 13 are electrically connected and the address signal at least carries IC addresses of the source driver ICs 14 with which the first output ports 13 are electrically connected. As shown in FIG. 7, the address of a source driver IC in the address signal and the pixel data of a source driver IC in the driving signal correspond to each other in a one-to-one relationship and are matched in a prescribed timing, and both correspond to one source driver IC 14, so that when the address signal and the driving signal are transmitted to all the source driver ICs 14, each source driver IC 14 can identify and receive the pixel data in the driving signal that corresponds to the source driver IC 14 according to the IC address thereof and the IC address carried in the address signal, and provide the data line with the pixel data pertaining to the source driver IC 14.

In an embodiment, the driving signal outputted by the first output ports 14 may also carry port information and/or control signal information of the first output ports 14. By enabling the driving signal to carry the port information of the first output ports 14, it can reduce the amount of data transmitted by the first output ports 14, thereby lowering the requirement of the output ports for band width when the timing controller outputs signals with fewer ports.

In an embodiment, the driving signal can also carry control signal information. The control signal may comprise one or several signals selected from the group consisting of an initial triggering signal, a clock signal, a latch signal and a polarity reversal signal. By enabling the driving signal to carry the control signal information, it can further reduce the number of output ports, thereby avoiding the circumstance that the timing controller also needs additional output ports to output the control signals required by the source driver ICs or the gate driver ICs.

The encoding module of the timing controller described with reference to FIGS. 5 to 7 provides the first output ports with the driving signal that at least carries the pixel data of the source driver ICs, and the second output port with the IC addresses of the source driver ICs, such that one of the first output ports can at least output the pixel data of two source driver ICs, thereby reducing the number of the output ports and lowering the production cost of the timing controller. Moreover the address signal and the driving signal are sent separately, which reduces the amount of data outputted by the timing controller at the same time and thereby lowers the requirement of the timing controller for bandwidth while decreasing the number of output ports.

According to an embodiment, there is also provided a source driver IC electrically connected with the timing controller 1 as shown in FIGS. 2 and 3. FIG. 8 illustrates a structural schematic view of the source driver IC 4 in FIG. 2. As shown in FIG. 8, the source driver IC 4 comprises a first receiving port 7 and a decoding module 8. The first receiving port 7 can be configured to receive a driving signal outputted by a first output port 3 of the timing controller. The decoding module 8 can be configured to determine whether a current IC address in the driving signal matches a prestored address of the source driver IC in which the decoding module 8 itself is located, and configured to acquire the pixel data in the driving signal that corresponds to the current IC address if they match.

In an embodiment, the source driver IC may also comprise a storing module for storing the address of the source driver IC. The address of the source driver IC stored in the storing module is used to match the IC addresses of the source driver ICs in the driving signal.

The above source driver IC 4 is provided with the decoding module 8 used to determine whether a current IC address in the driving signal matches a prestored address of the source driver IC 4 in which the decoding module 8 itself is located, and to acquire the pixel data in the driving signal that corresponds to the current IC address if they match, so that the source driver ICs 4 can acquire the pixel data outputted by the timing controller and required by the source driver ICs 4.

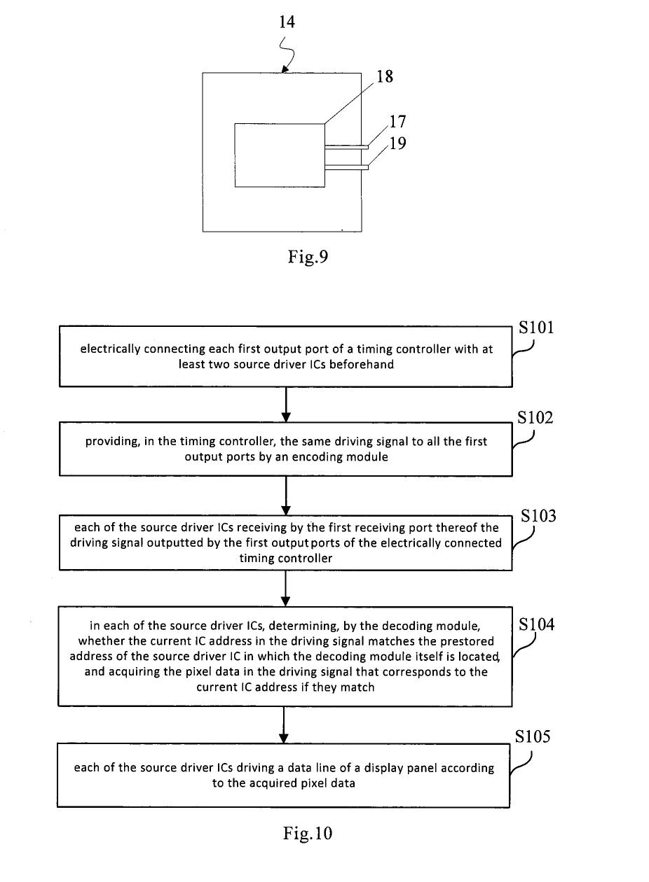

According to an embodiment, there is provided a source driver IC configured to be electrically connected with the timing controller as shown in FIGS. 5 and 6. FIG. 9 illustrates a structural schematic view of the source driver IC 14 in FIG. 5. As shown in FIG. 9, the source driver IC 14 comprises a first receiving port 17, a second receiving port 19 and a decoding module 18. The first receiving port 17 can be configured to receive a driving signal outputted by the first output port 13 of the timing controller, the second receiving port 19 can be configured to receive an address signal outputted by the second output port 10, and the decoding module 18 can be configured to determine whether a current IC address in the address signal matches a prestored address of the source driver IC in which the decoding module 18 itself is located, and configured to acquire the pixel data in the driving signal that corresponds to the current IC address if they match. The source driver 14 further transmits the pixel data to the pixel area of the display panel through the data line so as to drive the pixel unit of the pixel area for image display.

It needs to be explained that the source driver IC 14 may also comprise a storing module for storing the address of the source driver IC 14. The prestored address of the source driver IC 14 stored in the storing module is used to match the IC address of the source driver IC 14 in the driving signal.

The source driver IC as shown in FIG. 9 is provided with a decoding module used to parse the address signal of the source driver ICs outputted by the second output port in the timing controller in FIG. 5, and, when the current IC address matches the prestored address of the source driver IC 14 in which the decoding module itself is located, to acquire the pixel data corresponding to the current IC address and outputted by the first output ports of the Timing controller shown in FIG. 5. In doing so, the source driver IC 14 can further transmit the pixel data to the pixel area of the display panel through a data line so as to drive the pixel unit in the pixel area for image display.

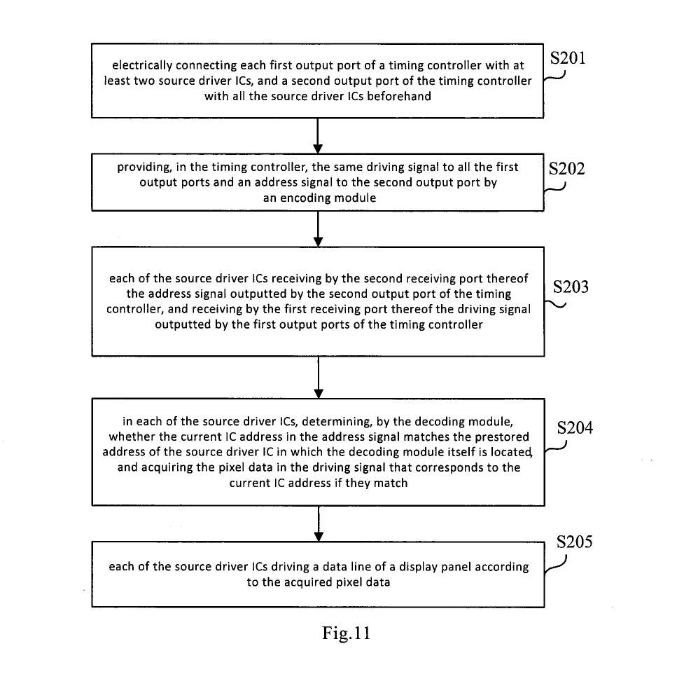

According to an embodiment, there is provided a source driving method. The method drives a plurality of source driver ICs shown in FIG. 2 or 8 by the timing controller shown in FIG. 2 or 3. With reference to the timing chart shown in FIG. 4, the driving flowchart of the source driver IC shown in FIG. 10 will be specially explained below:

S101: electrically connecting each first output port of a timing controller with at least two source driver ICs beforehand.

S102: providing, in the timing controller, the same driving signal to all the first output ports by an encoding module. The step S102 may further comprise the step of: in the timing controller, the data processing module converting the video data received by the input port of the timing controller into the pixel data corresponding to display panel pixel columns, and providing the pixel data to the encoding module; and the encoding module encoding and generating the driving signal based on the pixel data, and transmitting the driving signal to all the first output ports. Wherein the driving signal at least carries the IC addresses of the source driver ICs with which all the first output ports are electrically connected and the pixel data corresponding to the source driver ICs.

S103: each of the source driver ICs receiving the driving signal outputted by the first output ports of the electrically connected timing controller by the first receiving port thereof;

S104: in each of the source driver ICs, determining, by the decoding module, whether the current IC address in the driving signal matches the prestored address of the source driver IC in which the decoding module itself is located, and acquiring the pixel data in the driving signal that corresponds to the current IC address if they match. In an embodiment, the source driver IC can prestore the address of the source driver IC. For instance, with reference to FIG. 4, when the IC1 address in the driving signal outputted by the timing controller matches the address of the source driver IC, the source driver IC acquires the pixel data (IC1 pixel data) corresponding to the IC1 address in the driving signal.

S105: each of the source driver ICs driving a data line of a display panel according to the acquired pixel data.

In the above method, the timing controller outputs the driving signal that at least carries the addresses of the source driver ICs and the pixel data corresponding to the source driver ICs, and when it is determined that the current IC address in the driving signal matches the prestored address of the source driver IC in which the decoding module itself is located, the decoding module of the source driver IC acquires the pixel data corresponding to the current IC address in the driving signal, so that the driving signal outputted by the timing controller with fewer output ports can be parsed by more source driver ICs, and the source driver IC can acquire the required pixel data and drive the pixel unit for display.

According to another embodiment, there is provided a source driving method. The method drives a plurality of source driver ICs shown in FIG. 5 or 9 by the timing controller shown in FIG. 5 or 6. With reference to the timing chart shown in FIG. 7, the driving flowchart of the source driver IC shown in FIG. 11 will be specially explained below:

S201: electrically connecting each first output port of a timing controller with at least two source driver ICs, and a second output port of the timing controller with all the source driver ICs beforehand.

S202: providing, in the timing controller, the same driving signal to all the first output ports and an address signal to the second output port by an encoding module. The step S202 may further comprise the step of: the data processing module of the timing controller converting the video data received by the input port of the timing controller into the pixel data corresponding to display panel pixel columns, and providing the pixel data to the encoding module; and the encoding module encoding and generating the driving signal based on the pixel data, and generating the address signal that matches the pixel data. Wherein the driving signal at least carries the pixel data of the source driver ICs with which all the first output ports are electrically connected and the address signal carries the IC addresses of the source driver ICs with which all the first output ports are electrically connected.

S203: each of the source driver ICs receiving by the second receiving port thereof the address signal outputted by the second output port of the timing controller, and receiving by the first receiving port thereof the driving signal outputted by the first output ports of the timing controller.

S204: in each of the source driver ICs, determining, by the decoding module, whether the current IC′ address in the address signal matches the prestored address of the source driver IC in which the decoding module itself is located, and acquiring the pixel data in the driving signal that corresponds to the current IC address if they match. In an embodiment, the source driver IC can prestore the address of the source driver IC. For instance, with reference to FIG. 7, when the IC1 address in the address signal outputted by the timing controller matches the address of the source driver IC, the source driver IC acquires the pixel data (IC1 pixel data) corresponding to the IC1 address in the driving signal.

S205: each of the source driver ICs driving a data line of a display panel according to the acquired pixel data.

In the method as shown in FIG. 11, the first output ports of the timing controller output the driving signal that at least carries the pixel data corresponding to the source driver ICs, and the second output port of the timing controller outputs the addresses of the source driver ICs, and when it is determined that the current IC address in the address signal matches the prestored address of the source driver IC in which the decoding module itself is located, the decoding module of the source driver IC acquires the pixel data corresponding to the current IC address in the driving signal. In doing so, the address signal outputted by the timing controller can be parsed by the source driver ICs and the source driver ICs can acquire the required pixel data, such that the timing controller with fewer output ports can output the pixel data required by the source driver ICs, and the source driver ICs can drive the pixel units for display.

It can be understood that the above embodiments are only exemplary embodiments of the present invention, but not intended to limit the present invention. Those skilled in the art can make various modifications and variations of the embodiments without departing from the spirit and scope of the present invention. Any modifications and variations made within the spirit and scope of the present invention will fall within the scope of the claims of the present applications and equivalents thereof. The protection scope of the present invention shall be based on the protection scope of the appended claims.

What needs to be explained is that the above embodiments are only illustrated by way of the individual function modules division. In actual application, the above functions can be allocated to different functional modules as desired. The internal structure of the device can be divided into different functional modules so as to accomplish all or part of the functions as stated above. In addition, function(s) of the above one module can be achieved by a plurality of modules, and functions of the plurality of modules can be integrated into one module.

The present application uses wordings such as “first” and “second”. Unless specified in the context, the use of such wordings does not imply any ordering, but these wordings are actually used only for the purpose of identification. For instance, the phrases “a first output port” and “a second output port” do not necessarily mean that the first output port is located in front of the second output port in terms of position, or the first output port processes and outputs signals prior to the second output port in terms of time. In fact, these phrases are only used to identify different output ports.

In the claims, any reference signs in parentheses should not be interpreted as a limitation to the claims. The term “comprise/include” does not exclude the presence of elements or steps other than those listed in the claims. The words “a” or “an” in front of elements do not exclude the presence of a plurality of such elements. The present invention may be achieved by hardware comprising a plurality of separate elements, or by properly programmed software or firmware, or by any combination thereof.

In device or system claims that enumerate several means, one or more of the means can be embodied in one and the same item of hardware. The mere fact that some measures are recited in dependent claims that are different from each other does not indicate that the combination of the measures cannot be used to advantage.

1. (canceled)

2. (canceled)

3. (canceled)

4. (canceled)

5. (canceled)

6. (canceled)

7. (canceled)

8. A timing controller, comprising:
at least one first output port, each of which is configured to be electrically connected with at least two source driver integrated circuits IC;
a second output port configured to be electrically connected with the source driver ICs with which all the first output ports are electrically connected; and
an encoding module configured to provide the same driving signal to all the first output ports, the driving signal at least carrying pixel data corresponding to the source driver ICs with which all the first output ports are electrically connected, and the encoding module also configured to provide the second output port with an address signal carrying the IC addresses of the source driver ICs.

9. The timing controller according to claim 8, wherein the timing controller further comprises:
an input port configured to receive video data; and
a data processing module configured to convert the video data received by the input port into the pixel data corresponding to display panel pixel columns, and provide the pixel data to the encoding module.

10. The timing controller according to claim 9, wherein the encoding module is configured to encode the pixel data and generate the driving signal, generate the address signal matching the pixel data, and provide the driving signal to all the first output ports and the address signal to the second output port.

11. The timing controller according to claim 8, wherein the IC addresses of the source driver ICs in the address signal and the pixel data in the driving signal correspond to each other in a one-to-one relationship and are matched in a prescribed timing.

12. The timing controller according to claim 8, wherein the driving signal also carries port information and/or control signal information of the first output ports.

13. The timing controller according to claim 12, wherein the control signal comprises one or several signals selected from the group consisting of an initial triggering signal, a clock signal, a latch signal and a polarity reversal signal.

14. The timing controller according to claim 8, wherein the number of the first output ports may be one, and the one first output port is electrically connected with all the source driver ICs of the display panel; or the number of the first output ports may be at least two, and all the first output ports are electrically connected with all the source driver ICs of the display panel, and each of the first output ports is electrically connected with a portion of the source driver ICs of the display panel.

15. (canceled)

16. A source driver integrated circuit IC configured to be electrically connected with any timing controller according to claim 8, wherein the source driver IC comprises:
a first receiving port configured to receive a driving signal outputted by the first output port of the timing controller;
a second receiving port configured to receive an address signal carrying the IC addresses of the source driver ICs and outputted by the second output port of the timing controller; and
a decoding module configured to determine whether a current IC address in the address signal matches a prestored address of the source driver IC, and configured to acquire the pixel data in the driving signal that corresponds to the current IC address if they match.

17. (canceled)

18. A source driving method, which drives at least two source driver integrated circuits IC by any timing controller according to claim 8, wherein the method comprises the steps of:
electrically connecting each first output port of the timing controller with the at least two source driver ICs and electrically connecting a second output port of the timing controller with all the source driver ICs beforehand;
providing, in the timing controller, the same driving signal to all the first output ports and an address signal to the second output port by the encoding module, wherein the address signal carries the IC addresses of the source driver ICs with which all the first output ports are connected, and the driving signal at least carries the pixel data corresponding to the source driver ICs with which all the first output ports are electrically connected;
each of the source driver ICs receiving by the second receiving port thereof the address signal outputted by the second output port of the timing controller electrically connected with the source driver ICs, and receiving by the first receiving port thereof the driving signal outputted by the first output ports of the timing controller electrically connected with the source driver ICs;
in each of the source driver ICs, determining, by a decoding module, whether the current IC address in the address signal matches the prestored address of the source driver IC in which the decoding module itself is located, and acquiring the pixel data in the driving signal that corresponds to the current IC address if they match; and
each of the source driver ICs driving a data line of a display panel according to the acquired pixel data.
